(19) United States
(12) Patent Application Publication
(10) Pub. No.: US 2010/0126660 A1
(43) Pub. Date: May 27, 2010

(54) Method of making graphene sheets and applicatios thereor

(76) Inventor: David O'Hara, Tallahassee, FL (US)

Correspondence Address: John Wiley Horton, Attorney;Pennington, Moore, Wilkinson, Bell & Dunbar, P.A., 2nd Floor, 215 S. Monroe St,., Tallahassee, FL, 32301, US

(21) Appl. No.: 12/589,897

(22) Filed: Oct. 30, 2009

Related U.S. Application Data
(60) Provisional application No. 61/197,715, filed on Oct. 30, 2008.

(51) Int. Cl. B32B 38/10; B29C 65/50

(52) U.S. Cl. 156/249; 977/734; 977/840

(57) ABSTRACT

A method of making graphene sheets having a desired thickness. The method starts with Highly Oriented Pyrolytic Graphite (“HOPG”). A plurality of graphene layers are pulled off of the HOPG and attached to a substrate. An adhesive device is then used to pull a selected number of graphene layers off of the HOPG sample attached to the substrate. The number of layers selected determines the thickness of the graphene sheet produced. The graphene sheet has many applications. It is particularly suitable as an X-ray window.

### CROSS-REFERENCES TO RELATED APPLICATIONS

This is a non-provisional application claiming the benefit, pursuant to 37 C.F.R. §1.53, of an earlier-filed provisional application. The provisional application was assigned Ser. No. 61/197,715. It was filed on Oct. 30, 2008 and it listed the same inventor.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

This invention relates generally to the field of X-ray equipment. More particularly, the present invention comprises a graphene X-ray window and methods for attaching the window.

2. Description of the Related Art

An X-ray detector typically includes a housing to contain the detection element. The housing must be sealed in order to contain a vacuum or a segregated gas. A “window” is typically provided to admit the X-rays to the detection element.

Fabrication of windows for low energy X-ray detectors has been problematic because most materials severely attenuate extremely low energy X-rays. For energies above 1 keV, Beryllium windows are often used but it is difficult to make extremely thin Be windows without pinholes. The presence of such pinholes compromise the sealing properties of the window.

Stretched polypropylene has also been used to make low energy X-ray windows but these are often too thick for energies down to 100 eV and the failure rate is very high. Recently, Moxtek, Inc. of Orem, Utah, has been making very thin polyimide windows with various coatings that work fairly well for very low energy X-rays. However, the polyimide windows still attenuate X-rays in the energy range below 100 eV and they also slowly leak so they cannot be used in ultra-high vacuum (“UHV”) systems.

Researchers have recently shown that monolayers of graphene (single layers of carbon in a hexagonal array) not only have high tensile strength to resist bursting when several atmospheres of pressure are applied, but they also do not allow passage of Helium. If they will not allow Helium to pass, they also will not allow various detector gasses to pass. This means that ultra-thin layers of graphene as either mono-or many layered films will be very good detector windows for radiation extending down from the soft x-ray region into the vacuum ultraviolet (“VuV”) region as well. Such windows would be good for UHV applications where no leakage can be allowed.

### BRIEF SUMMARY OF THE PRESENT INVENTION

The present invention is a method of making graphene sheets having a desired thickness. The method starts with Highly Oriented Pyrolytic Graphite (“HOPG”). A plurality of graphene layers are pulled off of the HOPG and attached to a substrate. An adhesive device is then used to pull a selected number of graphene layers off of the HOPG attached to the substrate. The number of layers selected determines the thickness of the graphene sheet produced. The graphene sheet has many applications. It is particularly suitable as an X-ray window.

### BRIEF DESCRIPTION OF THE SEVERAL VIEWS OF THE DRAWINGS

FIG. 1 is a plot of transmission versus X-ray energy for a window made of graphene and a window made of polyimide.

FIG. 2 is an elevation view showing the use of an adhesive cylinder.

### REFERENCE NUMERALS IN THE DRAWINGS

| | | | |
|---|---|---|---|
| 10 | adhesive cylinder | 12 | center |
| 14 | substrate | 16 | HOPG |
| 18 | conforming HOPG | | |

### DETAILED DESCRIPTION OF THE INVENTION

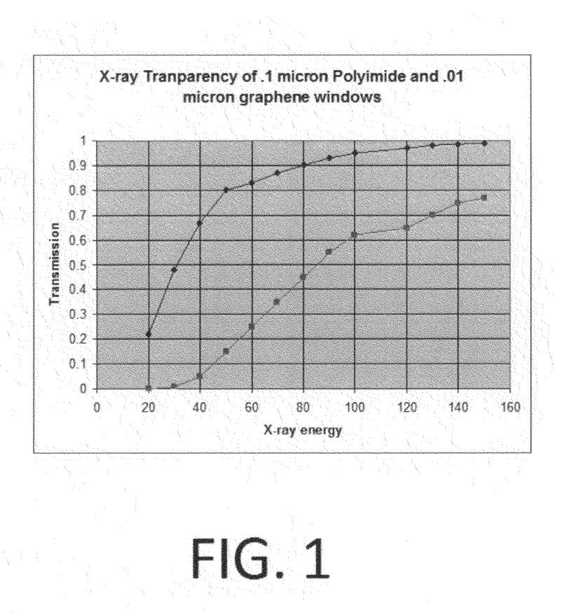

FIG. 1 shows a plot of transmission versus X-ray energy for a graphene window and a polyimide window. The graphene window is the upper curve and the polyimide is the lower curve. The graphene window is made of about 20 individual layers of graphene, having a combined thickness of 0.02 microns. The reader will observe that the graphene window of 0.02 micron thickness would pass 50% of 40 eV radiation and 65% of 54 eV Li(K) x-rays. In order to obtain good transmissibility for even longer wavelength detection, 10 layers of graphene could be used.

Researchers at Cornell University showed a path toward production of such windows by attaching graphene to scotch tape and then applying the tape to a silicon wafer. The present invention proposes applying a very thin layer of adhesive to a micromachined silicon, silicon nitride or electroformed grid with tiny holes. Sheets of highly oriented Pyrolytic graphite (“HOPG”) would be stuck to double stick tape to peel off a large number of layers from the thick HOPG. The tape with HOPG is then applied to the grid and peeled off leaving behind graphene layers. Alternatively, as discussed by the Cornell researchers, Van derWaals forces could be used without an adhesive on the grid to hold the graphene layers.

It may be necessary to apply a thicker layer of material to the Graphene to make it opaque to longer wavelength light. A boron hydride layer is suitable for this purpose. In addition, it may be necessary to apply an ultra-thin coating such as the vapor depositable polymer parylene to the window to hold the multiple pieces of graphene together if they are not continuous across the window opening. It is not necessary that this polymer be a continuous film

Graphene windows such as used in the present invention may also be useful for their electron transparency. Ultra-thin silicon nitride windows have been used to image wet specimens in an electron microscope because the ultra-thin window is transparent to the high energy electrons but does not allow passage of the gas from the wet specimen. In the same way, ultra-thin graphene windows can be used to allow passage of electrons but not gas. The advantage of graphene is that it would allow for passage of lower energy electrons to achieve higher analytical resolution.

For electron transparency of a window material, the mean free path for elastic scattering is given by:

λ=6.17×10¹⁹×AE²/(NρZ²cot(φ/2)) (1)

where:

λ=mean free path in cm

A=Atomic weight

E=E in KeV for the incident electrons

N=Avagodro's number

Z=Atomic number

φ=a scattering angle.

Equation (1) shows that the mean free path increases as the electron voltage squared so that a 5 KV electron has only 2.7% of the mean free path of a 30 KV electron in the same window material. However, the mean free path goes as Z squared so using an average atomic number of 9.57 for Si₃N₄ and a density of 3.44 for Si₃N₄ and 2.1 for graphene shows that for a given electron energy and thickness, graphene should have a mean free path of 4× that of Si₃N₄.

Silicon nitride is commercially available in thickness down to 100 nm so we will assume 50 nm which is 5× as thick as our proposed 10 layer graphene windows. So for 5 KV electrons, we should get about 0.54 (roughly half) the intensity of un-elastically scattered electrons through the graphene as is obtained through a thicker Si₃N₄ window at 30 KV. If we can decrease the window thickness to 5 layers, the intensity of un-elastically scattered electrons at 5 KV through our graphene window is the same as for the thicker Si₃N₄ window at 30 KV.

Comparing the thermal conductivity of graphene to Si₃N₄:
Si₃N₄ 15 W/M/K
Graphene 4800 W/m/K

Graphene should therefore be able to dissipate the heat loading produced by high electron beam currents far better than Si₃N₄. Graphene is also the “strongest” material known with a Youngs Modulus measured to be 0.5 TPa.

Highly Oriented Pyrolytic Graphite (“HOPG”) is an interesting material that resembles mica in structure except it is black and opaque. It is a crystalline form of graphite consisting of laminar sheets with each sheet being a single layer of graphene but the sheets are actually made of flakes of graphene of various sizes some misoriented with respect to the others so it is a very imperfect crystal. HOPG can be made in various levels of crystal imperfection and this imperfection can be very useful. The commercial grades are ZYA, ZYB, and ZYC with ZYA having the best degree of perfection. The degree of imperfection is given by the “mosaic spread” with the most ordered material having the lowest mosaic spread. Material with high mosaic spread cleaves with many steps because it has many misaligned areas of graphene whereas low mosaic spread gives few steps.

Layers of graphene can be removed from the thick HOPG using the “Scotch Tape Method” where tape is placed adhesive side down onto the HOPG and pulled up causing some number of layers to adhere to the tape. The tape is then placed HOPG side down on the substrate and bonded to the substrate using an adhesive such as epoxy. Acetone is then used to remove the tape leaving the graphene layers on the substrate. Unfortunately, this often fails to leave enough layers of graphene and sometimes none in places. The standard “Scotch Tape Method” really is the state of the art in cleaving HOPG for micro-analysis but does not allow a reproducible number of layers to be produced.

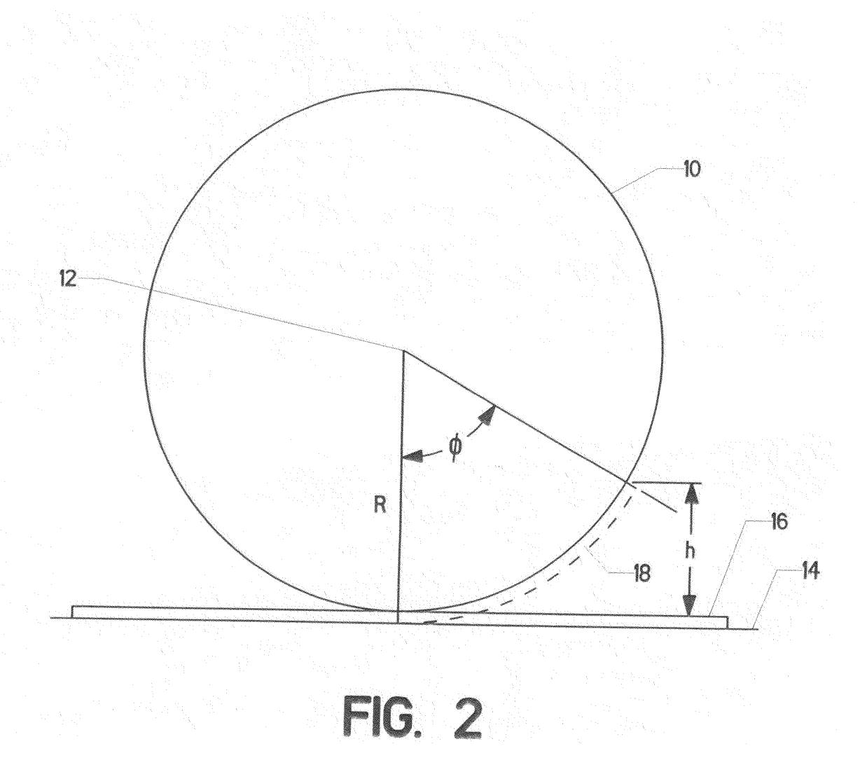

The present invention proposes a more controlled variation on the “Scotch Tape Method” that is likely to allow the transfer of a controlled number of layers of graphene to a substrate. FIG. 2 schematically depicts adhesive cylinder 10 rolling over HOPG 16 placed on substrate 14. The radius and rotation is measured with reference to center 12. If the adhesive cylinder rolls across a thick layer of HOPG, the number of layers of HOPG that adhere to the cylinder increases as the cylinder radius increases. Assume a thick layer of HOPG (of thickness w and each layer being Δ thick for a total number of layers of w/Δ=N) is forced to conform to the adhesive cylinder as shown (conforming HOPG 18) and then released. The thick HOPG acts like a bent beam and is subject to a restoring force that is proportional to the displacement h. When this restoring force Fᵣ becomes greater than the Van der Waals force (V) between the layers, it separates. Fᵣ is proportional to the number of layers separating from the cylinder so:
Fᵣ=nbh where b is a spring constant
   and

h=R(1−cos φ))

so:

nbR(1−cos φ)=V where V is the interlayer Van der Waals force.

The number of layers remaining on the cylinder is n*=N−n:

n*=N−V/(bR(1−cos φ)) φ>0 (2)

Equation (2) implies that for very large cylinder radii, all the layers stay on the cylinder and as the radius decreases the number of layers on the cylinder decreases.

### Production of Oxidized Graphene Paper

Commercial graphite consists of clumps of non-crystalline graphite mixed with multilayered flakes of crystalline graphite and it is this material which can form the starting point for producing graphene paper. The non-crystalline graphite must be removed from the bulk of the material and the remaining multilayered graphite separated into flakes of single layer material.

Graphite is a material made of up sheets of graphene. These graphene sheets are composed only of carbon atoms, are one atom thick, and the layers are only loosely held together. Graphene oxide consists of graphene layers with oxygen bound above and below the plane of carbon atoms. The oxygen atoms can attach to a single carbon atom as part of an alcohol group (OH) or can attach to two carbon atoms that are double bonded to each other to form an epoxide group. The arrangement of alcohol and epoxide on the plane appears to be random with some regions of the plane undecorated with oxygen.

A suspension of sheets of graphene oxide can be generated from graphite using a modified Hummers Method. This involves the simultaneous oxidation of the graphene in graphite in a process involving the strong oxidizing agents NaNO₃, H₂SO₄, and KMnO₄ and utlrasonic energy to mechanically separate the layers. Ultrasound alone can be used to separate the carbon sheets in graphite, but the resulting sheets are thicker than one atomic layer. Typically they are on the order of 50 nm thick. The graphene oxide sheets produced this way, however, are often one or two atoms thick. Typically ultrasound is applied for 5 days while the slurry of water, oxidizers, and graphite is gently stirred. This is then purified through a repeated process involving dilution in water followed by either centrifugation or precipitation. The resulting suspension is typically about 0.5 wt % graphene oxide.

Thin films of graphene oxide only a few atoms thick can be formed using vacuum filtration. Filter membranes with 25 nm pores are used in this process, and it is assumed that the uniformity of the resulting graphene-oxide layer occurs because the solution flows better through the uncovered pores. The resulting graphene-oxide sheets are not uniform, sheets from neighboring pores may overlap, and some regions may have thicknesses corresponding to many graphene-oxide sheets These graphene-oxide films have been applied to flat substrates by simply pressing the filter membrane (film-side down) onto the substrate and then dissolving the membrane with acetone.

Production of Graphene Films from Graphene Oxide Films

The graphene-oxide films can be used as deposited or the oxygen can be removed to form graphene films. The most efficient method found so far for removing the oxygen is a combination of exposure to hydrazine vapor for 24 hours followed by annealing at 200° C. for five hours. This in-situ reduction of graphene oxide is not complete, so some oxygen remains attached to the graphene films.

The reader will thereby appreciate that graphene films of suitable thickness can be produced using the disclosed methods. Such films are suitable for a variety of applications. Although the preceding descriptions contain significant detail they should not be viewed as limiting the invention but rather as providing examples of the preferred embodiments of the invention. Accordingly, the scope of the invention should be determined by the following claims, rather than the examples given.

Having described my invention, I claim:

1. A method of producing a sheet of graphene having a desired thickness, comprising:
a. providing a piece of Highly Oriented Pyrolytic Graphite;
b. providing a substrate;
c. applying an adhesive to said substrate;
d. pulling a plurality of graphene layers from said Highly Oriented Pyrolytic Graphite and attaching them to said substrate using said adhesive placed on said substrate;
e. providing an adhesive cylinder;
f. rolling said adhesive cylinder over said plurality of graphene layers on said substrate to selectively remove some of said graphene layers, thereby leaving a desired number of graphene layers on said substrate.

2. A method of producing a sheet of graphene as recited in claim 1, wherein said adhesive cylinder has a radius, and wherein said radius is selected to determine the number of graphene layers removed from said substrate for each pass of said adhesive cylinder.

3. A method of producing a sheet of graphene as recited in claim 1, further comprising:
a. providing a piece of double sided tape; and
b. wherein said step of pulling a plurality of graphene layers from said Highly Oriented Pyrolytic Graphite is performed by applying said piece of double sided tape to said Highly Oriented Pyrolytic Graphite and pulling said piece of double sided tape away.

4. A method of producing a sheet of graphene as recited in claim 2, further comprising:
a. providing a piece of double sided tape; and
b. wherein said step of pulling a plurality of graphene layers from said Highly Oriented Pyrolytic Graphite is performed by applying said piece of double sided tape to said Highly Oriented Pyrolytic Graphite and pulling said piece of double sided tape away.

5. A method of producing a sheet of graphene having a desired thickness, comprising:
a. providing a piece of Highly Oriented Pyrolytic Graphite;
b. providing a substrate;
c. pulling a plurality of graphene layers from said Highly Oriented Pyrolytic Graphite and attaching them to said;
d. providing an adhesive object; and
f. using said adhesive object to selectively remove some of said graphene layers from said substrate, thereby leaving a desired number of graphene layers on said substrate.

6. A method of producing a sheet of graphene as recited in claim 5, wherein said adhesive cylinder has a radius, and wherein said radius is selected to determine the number of graphene layers removed from said substrate for each pass of said adhesive cylinder.

7. A method of producing a sheet of graphene as recited in claim 5, further comprising:
a. providing a piece of double sided tape; and
b. wherein said step of pulling a plurality of graphene layers from said Highly Oriented Pyrolytic Graphite is performed by applying said piece of double sided tape to said Highly Oriented Pyrolytic Graphite and pulling said piece of double sided tape away.

8. A method of producing a sheet of graphene as recited in claim 6, further comprising:
a. providing a piece of double sided tape; and
b. wherein said step of pulling a plurality of graphene layers from said Highly Oriented Pyrolytic Graphite is performed by applying said piece of double sided tape to said Highly Oriented Pyrolytic Graphite and pulling said piece of double sided tape away.
